(19) United States
(12) Patent Application Publication
(10) Pub. No.: US 2020/0341727 A1
(43) Pub. Date: Oct. 29, 2020

(54) CONTROL DEVICE, CONTROL METHOD, NON-TRANSITORY COMPUTER-READABLE RECORDING MEDIUM, AND ELECTRONIC DEVICE

(71) Applicant: SHARP KABUSHIKI KAISHA, Osaka (JP)

(72) Inventors: YOSHICHIKA IIDA, Osaka (JP); YU YUMURA, Osaka (JP)

(21) Appl. No.: 16/811,541

(22) Filed: Mar. 6, 2020

(30) Foreign Application Priority Data
Apr. 26, 2019 (JP) 2019-086589

(51) Int. Cl. G06F 3/16; G06F 40/30

(52) U.S. Cl. CPC G06F 3/167; G06F 40/30

(57) ABSTRACT

A control device is configured to control an electronic device configured to present content to a user. The control device includes: an acquisition unit configured to acquire a plurality of contents and summary information on each of the plurality of contents; a summary presentation unit configured to output by voice the summary information on each of the plurality of contents being acquired; a selection accepting unit configured to accept a user input designating a content of the plurality of contents, based on the summary information output by voice; and a detail presentation unit configured to present a content for which selection is accepted.

### CROSS-REFERENCE TO RELATED APPLICATIONS

This application claims the benefit of priority to Japanese Patent Application Number 2019-086589 filed on Apr. 26, 2019. The entire contents of the above-identified application are hereby incorporated by reference.

### BACKGROUND

### Technical Field

The disclosure relates to an electronic device or the like that presents content selected by a user.

In JP 2006-171719 A, an interactive information system is disclosed that includes a news collection module that connects to the Internet and captures news, a news database that stores the captured news, and a conversation database that includes at least a general conversation database that stores questions and answers used for general conversations. The interactive information system further includes a conversation engine, and the conversation engine extracts a keyword from a user's speech recognized by a voice recognition device, searches for the keyword in at least one of the news database and the conversation database, and outputs retrieved content as a response.

### SUMMARY

However, in the technology disclosed in JP 2006-171719 A, the user needs to receive and interpret voice information consisting of a plurality of sentences, in order to sort out whether lust one information content is important to themselves or not. When receiving and interpreting the voice information, the user needs to continue to listen to the information content provided by voice. The user needs to continue to listen to the information content while experiencing a psychological burden, namely, without knowing how long the user will need to continue to listen, in other words, without knowing when the presentation of the series of (serial) voice information will end.

Further, since only the contents retrieved as a result of processing of the interactive system are presented, the user cannot select information important to themselves from the plurality of information contents presented substantially at the same time. During the interaction, the user does not know what other contents are available, until the other contents are presented by the interactive system.

An object of an aspect of the disclosure is to realize an electronic device or the like capable of using voice to allow a user to easily ascertain what kind of content can be acquired.

In order to solve the above-described problem, a control device according to an aspect of the disclosure is a control device configured to control an electronic device configured to present content to a user. The control device includes an acquisition unit configured to acquire a plurality of contents and summary information on each of the plurality of contents, a summary presentation unit configured to output by voice the summary information on each of the plurality of content being acquired, a selection accepting unit configured to accept a user input designating a content of the plurality of contents, based on the summary information output by voice, and a detail presentation unit configured to present a content for which selection is accepted.

According to an aspect of the disclosure, the user can easily ascertain what kind of content can be acquired by listening to the voice. Thus, since the user does not need to acquire all the information of the plurality of contents that can be acquired, a burden of the user can be reduced.

### BRIEF DESCRIPTION OF DRAWINGS

The disclosure will be described with reference to the accompanying drawings, wherein like numbers reference like elements.

FIG. 1 is a functional block diagram of a content presentation system according to a first embodiment of the disclosure.

FIG. 2 is an external view of a terminal according to the first embodiment of the disclosure.

FIG. 3 is an explanatory diagram illustrating examples of voice outputs and display screen transitions of the terminal, when a summary information presentation operation according to the first embodiment of the disclosure is performed.

FIG. 4 is an external view illustrating a screen of the terminal when a content presentation operation according to the first embodiment of the disclosure is performed.

FIG. 5 is a sequence diagram of the summary information presentation operation according to the first embodiment of the disclosure.

FIG. 6 is an explanatory diagram illustrating examples of voice outputs and display screen transitions of the terminal, when a summary information presentation operation according to a second embodiment of the disclosure is performed.

### DESCRIPTION OF EMBODIMENTS

### First Embodiment

An embodiment of the disclosure will be described in detail below.

### Configuration

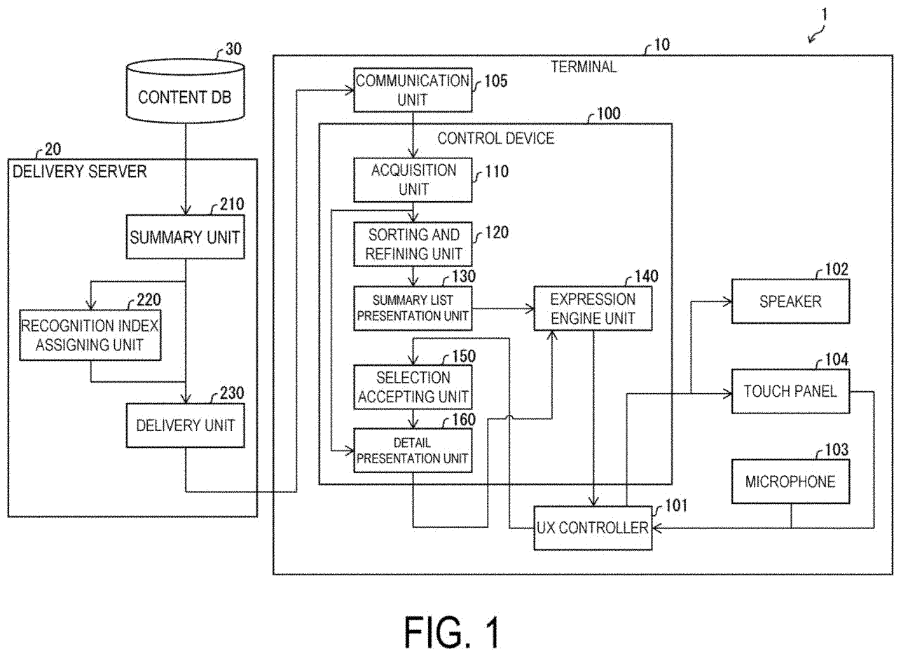

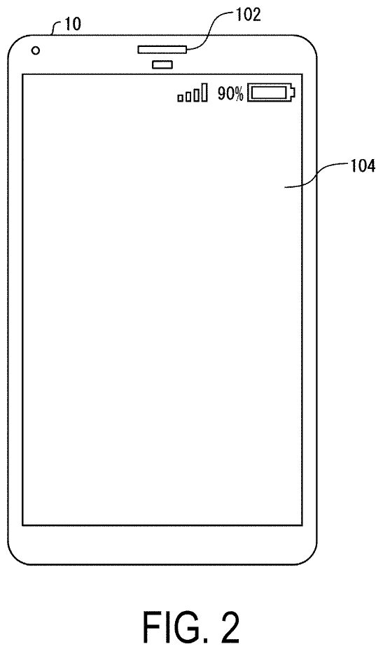

With reference to FIG. 1 and FIG. 2, functional blocks of a content presentation system 1 according to a first embodiment of the disclosure will be described.

The content presentation system 1 according to the first embodiment of the disclosure includes a content database (DB) 30, a delivery server 20, and a terminal 10 (an electronic device).

The content DB 30 includes at least one content C. Further, the content DB 30 sends the content C in response to a request from the delivery server 20. The content DB 30 is typically a server of a content provider providing news content, the server being installed on the Internet and accessible via the Web. However, the content is not limited to news and may be information about the weather, and the like. Further, the content is also not limited to new information delivered substantially in real time, such as the news and weather information, and may be past information published in, for example, newspapers, magazines, and the like.

The content C includes an ID number or a URL for identifying the content C, and content specific summary information CS (which is blank prior to summary processing), which will be described below. The content C is typically text content, but it is sufficient that the content C is content of a type for which the content specific summary information CS, which will be described below, can be created. For example, the content C may be voice content, image content, or video content.

The delivery server 20 includes a summary unit 210, a recognition index assigning unit 220, and a delivery unit 230.

The summary unit 210 acquires each of the contents C from the content DB 30, and generates the content specific summary information CS (summary information) from each of the contents C. Here, the content specific summary information CS is a sentence or a keyword describing an overview of the content C, for example.

In more detail, the summary unit 210 operates at a prescribed timing, such as every six hours, and generates the content specific summary information CS from the content for which the content specific summary information CS has not yet been generated, among the contents C that can be acquired from the content DB 30. A list of the contents C for which the content specific summary information CS has not yet been generated (or for which the summary information has been already generated), may be recorded in a DB (not illustrated).

The content specific summary information CS includes a keyword K typically consisting of several to between ten and twenty characters, and a summary S of the content, the summary S consisting of fewer characters than the content C.

Although examples of the technique for generating the content specific summary information CS from each of the contents C include an extraction summary method in which a portion of the existing content C is extracted, and a generation summary method in which a new sentence describing the overview of the target content C is generated from the extracted keyword known techniques can also be used for this purpose. When the control device 100 is configured to perform only a voice output of the keyword K in a summary list generation operation, which will be described below, any summary method may be used. When the control device 100 is configured to perform display of the summary S as well in the summary list generation operation, which will be described below, the generation summary method is preferably used. Note that when the content C is voice content, the content specific summary information CS is generated using a known technique. Similarly, when the content C is image content or video content, the content specific summary information CS is generated using a known technique suitable for each of the content types.

Note that the timing at which the summary unit 210 operates is not limited to the prescribed timing. For example, the summary unit 210 may generate the content specific summary information CS from the content C for which the content specific summary information CS has not yet been generated when an acquisition request from an acquisition unit 110, which will be described below, is received.

The recognition index assigning unit 220 assigns a recognition index to each of the contents C, the recognition index being an index indicating the degree of recognition of the keyword K. Specifically, the recognition index assigning unit 220 can acquire the recognition index of the keyword K from outside the delivery server 20, or from an internal DB (not illustrated). For example, the recognition index assigning unit 220 may acquire a number of search hits for the keyword K or a frequency of the keyword K being cited on social network services (SNS) from outside the delivery server 20, and, based on the acquired information, may determine and assign the recognition index to each of the keywords K. Alternatively, the recognition index assigning unit 220 may acquire the recognition index of the keyword K from the internal DB, which is based on past selection input histories of a plurality of the users of the content presentation system 1.

Note that, in order to simplify the explanation, it is assumed that the recognition index is handled for each of the contents C in sorting and refining processing, which will be described below. In this case, the recognition index of the content C may be an average value of all of the keywords K included in the content C (an average value appropriately selected according to the refining processing, which will be described below, such as the arithmetic average or the multiplication average).

The delivery unit 230 operates at every prescribed timing, and delivers the content C that has not yet been delivered and its content specific summary information CS, among the contents C received from the summary unit 210 or additionally received from the recognition index assigning unit 220. Note that, as will be described below in the operations section, the content C and its content specific summary information CS may be delivered in response to an explicit acquisition request from the terminal 10. The already delivered content C may be delivered, or if the acquisition request includes a designation of the content C, the designated content may be delivered.

The terminal 10 includes a control device 100, a UX controller 101, a speaker 102, a microphone 103, a touch panel 104 (a display device), and a communication unit 105. Note that the external appearance of the terminal 10 is illustrated in FIG. 2.

The UX controller 101 controls the speaker 102 and additionally the touch panel 104, based on voice data and additionally on display data received from an expression engine unit 140, which will be described below, and performs presentation to the user. In addition, the UX controller 101 transmits an operation (a selection input operation) input by the user from the microphone 103 and additionally from the touch panel 104 to a selection accepting unit 150.

The speaker 102 outputs voice in accordance with a signal received from the UX controller 101.

The microphone 103 detects voice including a voice instruction from the user, and transmits a signal to the UX controller 101.

The touch panel 104 performs display on a touch panel display in accordance with the signal received from the UX controller 101. In addition, a signal is transmitted to the UX controller 101 based on a touch panel operation detected by the touch panel 104.

The control device 100 includes the acquisition unit 110, a sorting and refining unit 120, a summary list presentation unit 130 (a summary presentation unit), the expression engine unit 140, the selection accepting unit 150, and a detail presentation unit 160.

The acquisition unit 110 acquires the content C delivered from the delivery unit 230, via the communication unit 105.

Additionally, the acquisition unit 110 may assign a user degree of interest index to each of the received contents C and keywords K in order to reflect interests and preferences of the user. Specifically, the selection accepting unit 150 stores, in a DB (not illustrated) , the keyword K of the content C for which the selection accepting unit 150 has accepted a selection input from the user. The selection accepting unit 150 assigns the user degree of interest index to each combination of the user who has performed the selection and the keyword K selected.

Note that, in order to simplify the explanation, It is assumed that the user degree of interest index is handled for each of the contents C in the sorting and refining processing, which will be described below. In this case, the user degree of interest index for the content C may be an average value of all of the keywords K included in the content C.

The sorting and refining unit 120 sorts and refines the contents C received from the acquisition unit 110, in accordance with a prescribed procedure. Further, the sorting and refining unit 120 performs refinement of the keywords K of each of the contents C.

The summary list presentation unit 130 generates and transmits a summary list B (summary information B in which a plurality of contents are bundled), based on each of the contents C received from the sorting and refining unit 120. The summary list presentation unit 130 transmits the generated summary list B to the expression engine unit 140.

The expression engine unit 140 generates voice data and display data to be presented to the user, based on the received summary list B or detailed content, which will be described below. The expression engine unit 140 transmits the generated data to the UX controller 101, and causes the summary list B or the detailed content to be presented to the user from the speaker 102 and the touch panel 104.

The summary list B includes the keyword K of at least one of the contents C so that at least one of the contents C can be concisely presented. Further, instead of the keyword K, the summary list B may include the summary S, which is a display text consisting of prescribed number of characters or less.

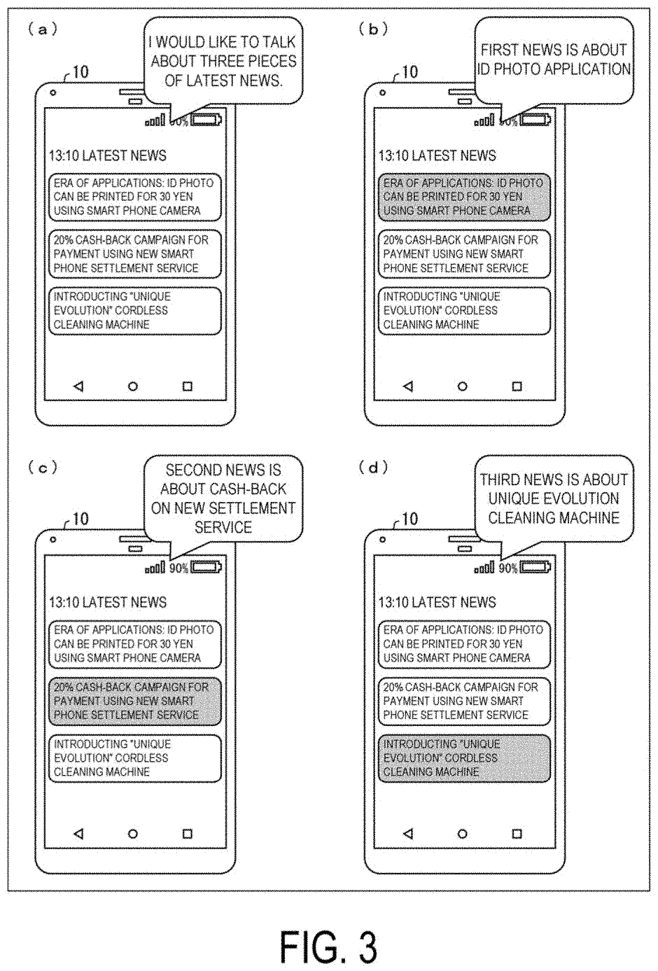

FIG. 3 is an explanatory diagram illustrating examples of voice outputs and display screen transitions, when a summary information presentation operation is performed in the terminal 10. Note that the summary information presentation operation is performed at step S123, which will be described below.

First, in FIG. 3(a), as the summary list B, the summaries S of the three contents C are displayed, and a message describing the entire summary list B, that is, “I would like to talk about three pieces of latest news” is output by voice. Next, in FIG. 3(b), the summary S of the first content C on the summary list B, that is, “Printed for 30 yen . . . ” is highlighted, and the keywords K of the content C, that is, “The first news is about ID photo application” is output by voice. After that, as illustrated in FIG. 3(c) and FIG. 3(d), the summaries S of the second and third contents C on the summary list B are highlighted, and the keywords K of the contents C are output voice.

In more detail, in summary list generation processing, the summary list presentation unit 130 acquires the number of the keywords K or the summaries S of the contents C received from the sorting and refining unit 120. In the example illustrated in FIG. 3, the summary list presentation unit 130 acquires information indicating that the number of the received contents C is three, and based on the information, generates a character string for a voice message describing the entire summary list B (an overall message character string), namely, “I would like to talk about three pieces of latest news.” Further, the summary list presentation unit 130 also acquires the keywords K of each of the contents C and an order of the contents C on the summary list B, and based on this, generates a character string for a voice message that includes the keywords K of each of the contents C.

Note that the keywords K that are output by voice may be all or some of the keywords K of the contents C. Specifically, the sorting and refining unit 120 may sort the keywords K based on the recognition index assigned to each of the keywords K and the user degree of interest index, and may extract the keywords K so that the high-ranking keywords K within a prescribed number of words are output by voice. As a result, the keywords K in which the user is interested can be preferentially presented. Alternatively, the keywords K may be selected based on a time required for the voice output thereof. Further, the keywords K may be selected so that differences between the contents C on the summary list B become distinctive. In this way, the keywords K to be presented can be selected so that the user can more swiftly make a judgment. It is thus possible to suppress an effort placed upon the user to once more listen to the plurality of pieces of news presented, and further, to alleviate a psychological burden on the user when paying close attention so as not to miss any information.

Further, the summary list presentation unit 130 may also acquire a prescribed time period specified at a time of acquiring the content C, and may reflect the time period in the overall message character string so that the message “I would like to tell you about the news within the past hour” is output, for example.

Further, when the sorting and refining unit 120 sorts the contents C using the user degree of interest index, the summary list presentation unit 130 may generate the overall message character string including this fact. As a result, the user can recognize how the refinement and sorting has been performed. Thus, the user can determine whether or not the method of refining and sorting is in line with his or her preferences, and can choose whether to continue to listen to the contents to be presented thereafter.

The selection accepting unit 150 accepts a user input for designating one or more of the contents from the summary list B presented by the summary list presentation unit 130. Specifically, the selection accepting unit 150 accepts a selection input (the user input) from the user including at least one of a voice input and a touch operation received from the UX controller 101, and determines the content selected by the user (a detail presentation content group).

The selection accepting unit 150 transmits the determined detail presentation content group to the detail presentation unit 160.

The detail presentation unit 160 receives, from the acquisition unit 110, details (original information from which the keyword K and the summary S are created) of the selected contents C, and sequentially presents the selected contents (detailed contents) of the contents C presented by the summary list presentation unit 130. A display order of each of the contents C may be the same as an order obtained as a result of the sorting and refining unit 120 performing the sorting.

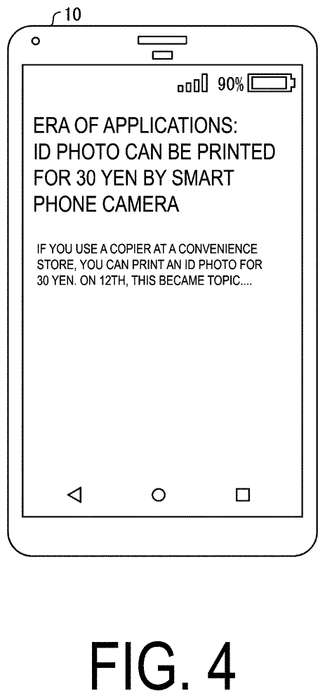

In FIG. 4, an example is illustrated in which one detailed content of the content C is displayed. In FIG. 4 details of the content C corresponding to the summary S displayed first from the top (in other words, the keywords K that are output by voice at the beginning) on the summary list B in FIG. 3(a) to FIG. 3(c) are displayed.

When presentation of all the detailed contents of each of the contents C selected by the user from the summary list B is completed, the detail presentation unit 160 performs end processing. Specifically, the summary list B generated by the summary list presentation unit 130 is deleted. At this time, all of the contents C acquired by the acquisition unit 110 may be deleted, or only the content C for which the detailed content has been displayed may be deleted and the remaining content C may be held in the terminal 10 so that it can be displayed next time. Alternatively, only the content C whose currentness is equal to or greater than a prescribed value may be held in the terminal 10.

### Operations

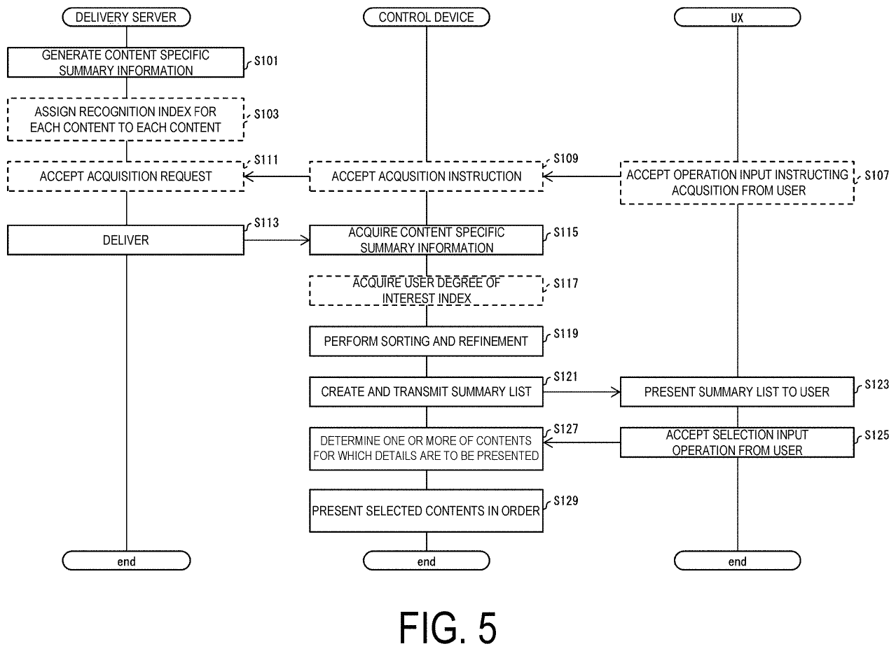

FIG. 5 is a sequence diagram of the summary information presentation operation according to the first embodiment of the disclosure. With reference to FIG. 5, an overview of each of steps from S101 to S129 will be described. Note that blocks indicated by dashed lines indicate additional operations.

At step S101, the summary unit 210 acquires each of the contents C from the content DB 30, and generates the content specific summary information CS, namely, the keywords K or the summary S of each of the contents C from the contents C for which the content specific summary information CS has not yet been generated, among the contents C that can be acquired from the content DB 30.

At step S103, the recognition index assigning unit 220 may acquire the number of search hits or the citation frequency on the social network services (SNS) of the generated keyword K, and based on these information, may assign the recognition index for each of the contents to each of the contents C.

At step S107, the UX controller 101 accepts, from the user, an operation input instructing the acquisition of the content C. The operation input instructing the acquisition may be, for example, a sliding operation, that is, an operation by the user pulling his/her finger downward on the touch panel 104, or may be a voice input. Note that when the operation input is performed, a portion of the content C may be designated using a check box or the like.

At step S109, the acquisition unit 110 accepts the acquisition instruction from the UX controller 101, and transmits an acquisition request to the delivery unit 230 via the communication unit 105 based on the acquisition instruction.

At step S111, the delivery unit 230 accepts the acquisition request.

At step S113, the delivery unit 230 that has accepted the acquisition request delivers the undelivered content C to the acquisition unit 110 via the communication unit 105. At this time, the delivery unit 230 transmits the added content specific summary information CS and recognition index to the acquisition unit 110 along with the content C. Note that when the acquisition request includes a designation of the content C, the designated content C is delivered.

At step S115, the acquisition unit 110 acquires the content C, and the content specific summary information CS and the recognition index added to the content C (an acquisition step).

At step S117, the acquisition unit 110 may assign the user degree of interest index to each of the acquired content C. After that, the sorting and refining unit 120 may acquire the user degree of interest index.

At step S119, the sorting and refining unit 120 sorts the contents C received from the acquisition unit 110 according to the prescribed procedure, and performs refinement so that the number of contents C falls within a prescribed number. Specifically, the refinement limits the number of summary lists B to be created at step S121, which will be described below. A specific example of the refinement performed by the sorting and refining unit 120 will be described later.

Note that the summary list presentation unit 130 or the detail presentation unit 160 may store an ID or an URL of the content C that has been already presented to the user, in a DB (not illustrated) provided inside the control device 100. In the above-described case, the sorting and refining unit 120 presents only the content C that has not yet been presented to the user. In this way, since the user can listen to the summary list B without taking account of duplication, the psychological burden on the user can be reduced.

At step S121, the summary list presentation unit 130 generates and transmits the summary list B based on each of the contents C received from the sorting and refining unit 120 and information associated with each of the contents C, such as the keywords K or the summary S.

The expression engine unit 140 generates voice data to be presented to the user based on the received summary list B, and transmits the voice data to the UX controller 101. Note that the expression engine unit 140 generates the display data based on the received summary list B and transmits the display data to the UX controller 101.

At step S123, the UX controller 101 transmits the voice data received from the expression engine unit 140 to the speaker 102 and causes the speaker to output the voice data. In other words, the summary list B is presented to the user (a summary information presentation step). Note that the UX controller 101 may transmit the display data received from the expression engine unit 140 to the touch panel 104 and cause the display data to be displayed on the touch panel 104. As the summary list B bundling the content specific summary information Cs of the plurality of contents C being presented, the plurality of contents C are presented substantially at the same time. The user can recognize what kind of options are available without acquiring all of the information of the plurality of contents C, and can then perform an input for designating some (or all) of the plurality of contents C.

At step S125, the UX controller 101 accepts the selection input operation from the microphone 103 by the user, and transmits the selection input operation to the selection accepting unit 150 (a selection acceptance step). Note that the selection may be performed with respect to the plurality of contents (designating a plurality of the contents) or with respect to one of the contents.

At step S127, the selection accepting unit 150 accepts the selection input from the user received from the UX controller 101, and determines one or more of a plurality of the contents (the detail presentation content group) for which the details (the original content C) are to be presented, among the contents C presented at step S123. For example, when the user gives a voice instruction saying “Cleaning machine and cash- back, please” the selection accepting unit 150 determines the contents matching the “cleaning machine” and the “cash-back” (the contents whose summaries S are presented second and third from the top in FIG. 3(a)) as the contents C selected by the user among the contents presented to the user.

Note that a situation in which no operation is performed may be detected, and in this case, only the summaries S may be presented in a continuous manner. More specifically, for example, a prescribed selection input acceptance period, such as 30 seconds, may be set, and when the selection accepting unit 150 does not detect any operation from the user within the prescribed selection input acceptance period, the selection accepting unit 150 may determine to cause all of the summaries S of the contents presented at step S123 to be continuously output by voice.

The selection accepting unit 150 transmits the determined contents C to the detail presentation unit 160.

Note that the selection accepting unit 150 may record an order of the selection made at step S127 so that an order in which the details are presented at step S129, which will be described below, can be determined. For example, when the user gives the voice instruction saying “cleaning machine and cash-back, please” at step S125, the selection accepting unit 150 makes a record that the summary S regarding the cleaning machine (the content whose summary S is presented third from the top in FIG. 3(a)) is to be presented first at step S129. Next, the selection accepting unit 150 makes a record that the summary S regarding the cash-back (the content whose summary S is presented second from the top in FIG. 3(a)) is to be presented second at step S129.

At step S129, the detail presentation unit 160 sends the details (detailed content) of the contents C to the expression engine unit 140, so that the selected contents C, among the contents C for which the content specific summary information CS is presented at step S121, are presented in order (a detail presentation step). Note that the detail presentation unit 160 may receive the details of the selected contents C from the acquisition unit 110.

The expression engine unit 140 generates voice data to be presented to the user based on the received detailed content and transmits the voice data to the UX controller 101. Alternatively, the expression engine unit 140 may generate display data and transmit the display data to the UX controller 101. Then, the UX controller 101 controls the speaker 102 and performs presentation to the user based on the received voice data. Alternatively, the UX controller 101 may control the touch panel 104 and perform the presentation to the user based on the received display data.

When the presentation of all of the detailed contents of the contents C presented at step S121 is completed, the detail presentation unit 160 performs end processing. Specifically, the operations of the UX controller 101 and the expression engine unit 140 are stopped, the summary list B generated by the summary list presentation unit 130 is deleted, and the content information acquired by the acquisition unit 110 is reset. Note that the detail presentation unit 160 may store, in the delivery server 20, information regarding which content C's detailed content has been selected by the user, in an interests and preferences database (not illustrated). In this way, the interests and preferences database can be updated based on the latest information regarding what kind of interests and preferences the user has.

Note that the specific example of the refinement performed by the sorting and refining unit 120 at step S119 described above is as follows. For example, the sorting and refining unit 120 sorts the contents C received from the acquisition unit 110 based on the update time (currentness), determines the contents C down to a prescribed ranking (that a prescribed number of contents) from the highest-ranking, namely, the most recent content C, and transmits the IDs of the contents C determined in this way to the summary list presentation unit 130. Note that the prescribed number may be two or more, such s two or three. The prescribed number may be within a commonly-used number (a so-called magic number) that a person can process in parallel at a time, or may be any number equal to or greater than the magic number that can be arbitrarily set by the user.

The sorting and refining unit 120 may perform the sorting while taking into account the recognition index assigned to the contents C by the recognition index assigning unit 220. For example, after performing the sorting based on the product of the recognition index and the currentness (the inverse number of time elapsed from the update time of the content C to the time of performing the refining processing, for example), the contents C may be refined from the highest-ranking content C down to the content C whose ranking is the prescribed number. In this way, the sorting may be performed with respect to the news in which the general public is highly interested, based on the product of the recognition index, the user degree of interest index, and the currentness, while eliminating news whose update time is too old or news in which the general public is not particularly interested. Further, a configuration may be adopted in which the sorting and refining processing is performed using different weighting for each content. Alternatively, the processing may be performed in an ordered manner, for example, after performing rough refining processing down to a second prescribed ranking using the user degree of interest index, refinement may be further performed down to a third prescribed ranking using the recognition index, and final refinement may be performed down to the content whose ranking is the prescribed number using the currentness. Much of the above depends on which factors are important to the user, namely, which one of the use own interests and preferences, recognition among the general public, and the currentness of the content is important to the user.

### Second Embodiment

Another embodiment of the disclosure will be described below. Note that, for convenience of explanation, components having the same function as those described in the above-described embodiment will be denoted by the same reference sighs, and descriptions of those components will be omitted.

A second embodiment mainly differs from the first embodiment in that the summary list B is created so as to include the number of keywords K that can be read out within a prescribed time period, for example, within one minute.

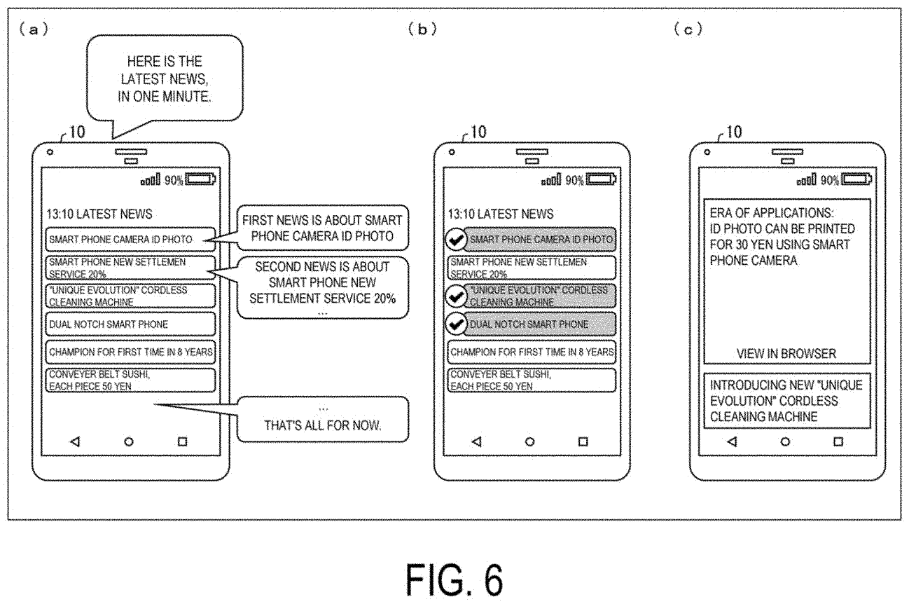

FIG. 6 is an explanatory diagram illustrating examples of voice outputs and display screen transitions when the summary information presentation operation is performed is the terminal 10.

In FIG. 6(a), the summaries S of the six contents C are displayed as the summary list B. Along with this, at first, a message describing the entire summary list B, that is, “Here is the latest news, in one minute” is output by voice. Subsequently, messages of the keywords K of the contents C included in the summary list B are sequentially output by voice. After the message of the keywords K of the last content C whose voice output fits within one minute is output by voice, an end message “That's all for now” is output by voice. Note that although only the six contents C that fit within the screen are presented in FIG. 6(a), the voice output may be performed for the contents that do not fit within the screen.

Next, the user checks the voice output and the screen display of FIG. 6(a), and operates the touch panel 104 to select the content C for which the user wants the details to be presented. As illustrated in FIG. 6(b), the color of the selected content C changes, and a check mark is added to the selected content C. Note that, similarly to the first embodiment, the selection input may be performed by voice.

Next, as illustrated in FIG. 6(c), the detail presentation unit 160 sequentially presents the selected contents C. Note that, in FIG. 6(c), an example is given of a case in which the contents C are displayed on the touch panel 104, but, similarly to the first embodiment, the contents C may be presented by voice.

### Modification

When the summary list B is displayed as illustrated in FIG. 3(a) to FIG. 3(d), FIG. 6(a), FIG. 6(b), and the like, the summaries S of the contents C (more accurately, screen elements displayed so as to correspond to the summaries S) may be presented to the user sequentially starting with the summary S displayed at the top on the terminal 10, while accepting, from the user, an operation of exchanging the contents C in the up-down direction through the sliding operation. In this way, the user can intuitively manipulate the order of the contents C the user wants to view and listen to.

At step S117, the description is given that the sorting and refining unit 120 of the terminal 10 performs the operation of assigning the user degree of interest index that reflects the user's interests and preferences, but the disclosure is not limited to this example. For example, instead of the sorting and refining unit 120 of the terminal 10 performing the above-described operation, the delivery server 20 may assign the user degree of interest index that reflects the user's interests and preferences. In this way, the delivery server 20 can assign the user degree of interest index that reflects the user's interests and preferences in advance before the delivery. Thus, it is not necessary to perform the processing in the terminal 10 as described above, and a decrease in calculation load and high-speed processing' can be expected. In this case, when the detail presentation unit 160 performs the end processing at step S129, the detail presentation unit 160 may transmit, to the delivery server 20, information regarding which content C's detailed content has been selected by the user. As a result, in the delivery server 20, it is possible to update the interests and preferences database using the latest information regarding what kind of interests and preferences the user has.

In order to simplify the explanation, it is described above that' the average value of each of the recognition index and the users degree of interest index is handled for each of the contents C in the sorting and refining processing, but the processing may be performed for each of the keywords K of each of the contents C. In this way, the sorting and refinement can be performed at the keyword level. For example, weighting of search results retrieved by a keyword whose recognition is low may be lowered. Thus, it is possible to present the contents important to the user more appropriately. As a result, the psychological burden on the user can be reduced.

### Implementation Example by Software

A control block of the control device 100 (particularly, the acquisition unit 110, the sorting and refining unit 120, the summary list presentation unit 130, the expression engine unit 140, the selection accepting unit 150, and the detail presentation unit 160) may be implemented by a logic circuit (hardware) formed on an integrated circuit (an IC chip) or the like, or may be implemented by software.

In the latter case, the control device 100 is provided with a computer that executes commands of a program, which is software for implementing each function. This computer includes at least one processor (a control device), for example, and includes at least one computer-readable recording medium that stores the above-described program therein. Then, an object of the disclosure is achieved by the processor reading the program from the recording medium and executing the program in the computer. A central processing unit (CPU) can be used as the processor, for example. As the recording medium, for example, a “non-transitory tangible medium” such as a read-only memory (ROM), a tape, a disk, a card, a semiconductor memory, a programmable logic circuit, and the like, can be used. In addition, a random access memory (RAM) and the like configured to deploy the program may further be provided. Further, the program may be supplied to the computer via any transmission medium (communication network, broadcast wave, or the like) capable of transmitting the program. Note that an aspect of the disclosure may be implemented in a form of a data signal embedded in a carrier wave, which is embodied by electronic transmission of the program.

### Supplement

A control device according to a first aspect of the disclosure is a control device configured to control an electronic device configured to present content to a user. The control device includes an acquisition unit configured to acquire a plurality of contents and summary information on each of the plurality of contents, a summary presentation unit configured to output by voice the summary information on each of the plurality of contents being acquired, a selection accepting unit configured to accept a user input designating a content of the plurality of contents, based on the summary information output by voice, and a detail presentation unit configured to present a content for which selection is accepted.

According to the above-described configuration, the user can easily ascertain what kind of content can be acquired by listening to the voice. Since the user does not need to acquire all the information of the plurality of contents, a burden on the user can be reduced.

In the control device according to a second aspect of the disclosure, with respect to the first aspect, the summary presentation unit may display a list of the summary information substantially simultaneously with outputting the summary information by voice.

According to the above-described configuration, the contents can be visually displayed while the user listens to the voice output of the content. Thus, the burden on the user can be reduced.

In the control device according to a third aspect of the disclosure, with respect to the first or second aspect, the selection accepting unit may accept a user input designating one or more of the plurality of contents.

According to the above-described configuration, the designation of the plurality of contents can be accepted from the user. Thus, the user can acquire a plurality of only the contents in which the user is interested. At this time, since details of only the plurality of contents designated by the user are displayed, the user knows in advance which contents' details are to be presented. Thus, a psychological burden on the user can be reduced.

In the control device according to a fourth aspect of the disclosure, with respect to the third aspect, the detail presentation unit may present the one or more of the plurality of contents in order of acceptance by the selection accepting unit.

According to the above-described configuration, the user can acquire contents of the content in order of selection by the user. In this way, the user does not need to separately select the order, and can easily acquire the content.

In the control device according to a fifth aspect of the disclosure, with respect to any one of the first to fourth aspects, the summary information may be a sentence or a keyword describing an overview of each of the plurality of contents.

A control method for an electronic device according to a sixth aspect of the disclosure is a control method for an electronic device configured to present content to a user. The method includes acquiring a plurality of contents and summary information on each of the plurality of contents, outputting by voice the summary information on the plurality of contents being acquired, accepting a user input designating a content of the plurality of contents, based on the summary information output by voice, and presenting a content for which selection is accepted. According to the above-described configuration, effects similar to those of the first aspect are achieved.

The control device according to each of the aspects of the disclosure may be implemented by a computer. In this case, a control program of the control device that implements the control device described above by causing a computer to function as each unit (software element) provided in the control device, and a computer-readable recording medium that stores the control program also fall within the scope of the disclosure.

An electronic device according to a seventh aspect of the disclosure includes the control device according to any one of the first to fifth aspects, at least one speaker, at least one display device, and at least one storage device. According to the above-described configuration, effects similar to those of the first to fifth aspects are achieved.

The disclosure is not limited to each of the above-described embodiments. It is possible to make various modifications within the scope of the claims. An embodiment obtained by appropriately combining technical elements each disclosed in different embodiments falls also within the technical scope of the disclosure. Furthermore, technical elements disclosed in the respective embodiments may be combined to provide a new technical feature.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A control device configured to control an electronic device configured to present content to a user, the control device comprising:
an acquisition unit configured to acquire a plurality of contents and summary information on each of the plurality of contents;
a summary presentation unit configured to output by voice the summary information on each of the plurality of contents being acquired;
a selection accepting unit configured to accept a user input designating a content of the plurality of contents, based on the summary information output by voice; and
a detail presentation unit configured to present a content for which selection is accepted.

2. The control device according to claim 1,
wherein the summary presentation unit is configured to display a list of the summary information substantially simultaneously with outputting the summary information by voice.

3. The control device according to claim 1,
wherein the selection accepting unit is configured to accept a user input designating one or more of the plurality of contents.

4. The control device according to claim 3,
wherein the detail presentation unit is configured to present the one or more of the plurality of contents in order of acceptance by the selection accepting unit.

5. The control device according to claim 1,
wherein the summary information is a sentence or a keyword describing an overview of each of the plurality of contents.

6. A control method for an electronic device configured to present content to a user, the control method comprising:
acquiring a plurality of contents and summary information on each of the plurality of contents;
outputting by voice the summary information on each of the plurality of contents being acquired;
accepting a user input designating a content of the plurality of contents, based on the summary information output by voice; and
presenting a content for which selection is accepted.

7. A non-transitory computer-readable recording medium storing a control program causing a computer to function as the control device according to claim I,
wherein the control program causes a computer to function as each of the acquisition unit, the summary presentation unit, the selection accepting unit, and the detail presentation unit.

8. An electronic device comprising:
the control device according to claim 1;
at least one speaker;
at least one display device; and
at least one storage device.
